(19) United States
(12) Patent Application Publication
(10) Pub. No.: US 2016/0254990 A1
(43) Pub. Date: Sep. 1, 2016

(54) SELF-HEALING CAM DATAPATH IN A DISTRIBUTED COMMUNICATION SYSTEM

(71) Applicant: ALCATEL-LUCENT CANADA, INC., OTTAWA (CA)

(72) Inventor: Toby J. Koktan, Dunrobin (CA)

(73) Assignee: ALCATEL-LUCENT CANADA, INC.

(21) Appl. No.: 14/633,589

(22) Filed: Feb. 27, 2015

(51) Int. Cl. H04L 12/703; H04L 12/26; H04L 12/743

(52) U.S. Cl. CPC H04L 45/28; H04L 45/7457; H04L 43/0847; H04L 43/0817

(57) ABSTRACT

Various embodiments include a method for monitoring a Content Addressable Memory (CAM). The method may include performing CAM hardware error polling, determining that a stored data soft error or datapath link error is present, comparing the number of stored data soft errors or datapath link errors to a threshold, when the number of stored data soft errors or datapath link errors is less than the threshold, invoking a master line-card stored data refresh process, determining a datapath port link error's detection; and when a datapath port link is down or persistent errors are present, invoking a datapath port link recovery process including hardware error polling to ascertain whether the recovery process was successful

### TECHNICAL FIELD

Various embodiments disclosed herein relate generally to data networks and more specifically memory management used in networking products.

### BACKGROUND

Content Addressable Memory (CAM) hardware devices are commonly employed in today's high performance communication systems for fast routing lookups and packet classification. Ternary CAM (TCAM) is a specific type of CAM which includes a third matching state such as “don't care.” A CAM search may compare a header of an incoming packet against entries in a forwarding table or a classifier database in parallel. The lookup result may be returned with a fixed latency regardless of record location and number of records or the routing table scale in the CAM. Applications of CAM include Internet Protocol version 4 and 6 (IPv4, IPv6) packet routing and Access control lists (ACLs) for node security. Reliable operation requires maintaining data integrity of data stored in the CAM device.

### SUMMARY

A brief summary of various embodiments is presented. Some simplifications and omissions may be made in the following summary, which is intended to highlight and introduce some aspects of the various embodiments, but not to limit the scope of the invention. Detailed descriptions of an embodiment adequate to allow those of ordinary skill in the art to make and use the inventive concepts will follow in later sections.

Various embodiments relate to a method for monitoring a Content Addressable Memory (CAM) including: performing CAM hardware error polling; determining that a stored data soft error is present; comparing the number of stored data soft errors to a threshold; when the number of stored data soft errors is less than the threshold, invoking a master line-card stored data refresh process; determining a datapath port link error's detection; and when a datapath port link error is present, invoking a datapath port link recovery process including hardware error polling.

Various embodiments are described wherein: when the number of stored data soft errors is larger than the threshold, indicating a hardware fault and halting operation.

Various embodiments are described wherein: when the master stored data refresh process is not successful, indicating a hardware fault and halting operation.

Various embodiments are described including determining if a datapath port link is down or an error is detected; and when a datapath port link error is detected, and is not recoverable, indicating a hardware fault and halting operation.

Various embodiments are described wherein when a datapath port link error is no longer detected following a recovery operation, determining if a error clearing period has expired.

Various embodiments are described wherein, when the error clearing period has expired, performing a CAM master database refresh process and determining if the CAM master database refresh process was successful.

Various embodiments are described wherein the CAM is a ternary CAM connected to a linecard.

Various embodiments are described including booting up a CAM slave line card; error monitoring the CAM on the slave line card by polling; when a soft-error or datapath link error is detected, determining if the number of errors is greater than a threshold; when the number of errors is less than a threshold, invoking a CAM slave database refresh process; when the number of errors is greater than a threshold, indicating a hardware fault and halting operation.

Various embodiments are described including a device used for monitoring a Content Addressable Memory (CAM), the device including: a memory; and a processor configured to: perform CAM hardware error polling; determine that a stored data soft error or datapath link error is present; compare the number of errors to a threshold; when the number of errors is less than the threshold, invoking a master stored data refresh process; determine a datapath port link error's detection; and when persistent datapath port link errors or link down exists, invoke a datapath port link recovery process including hardware error polling.

Various embodiments are described wherein when the number of stored data soft errors or datapath link errors is larger than the threshold, the processor is further configured to indicate a hardware fault and halt operation.

Various embodiments are described including a tangible and non-transitory machine-readable storage medium encoded with instructions thereon for executing a method for monitoring a Content Addressable Memory (CAM), wherein said tangible and non-transitory machine-readable storage medium comprises: instructions for performing CAM hardware error polling; instructions for determining that a stored data soft error or datapath link error is present; instructions for comparing the number of errors to a threshold; when the number errors is less than the threshold, invoking a master line-card stored data refresh process; instructions for determining a datapath port link error's detection; and when persistent datapath port link errors or link down exists, invoking a datapath port link recovery process including hardware error polling to ascertain success or failure of the operation.

Various embodiments are described wherein: when the number of stored data soft errors or datapath link errors is larger than the threshold, indicating a hardware fault and halting operation.

Various embodiments are described wherein: when the master stored data refresh process is not successful, indicating a hardware fault and halting operation.

Various embodiments are described including: instructions for determining if a datapath port link is down or experiencing persistent errors; and when a datapath port link error is detected, indicating a hardware fault and halting operation.

Various embodiments are described including a tangible and non-transitory machine-readable storage wherein when a datapath port link error is no longer detected following a recovery operation, determining if an error clearing period has expired.

Various embodiments are described including a tangible and non-transitory machine-readable storage medium wherein, when the error clearing period has expired, performing a CAM master database refresh process and determining if the CAM master database refresh process was successful.

Various embodiments are described including a tangible and non-transitory machine-readable storage medium wherein the CAM is a ternary CAM connected to a linecard.

Various embodiments are described including a tangible and non-transitory machine-readable storage medium including instructions for booting up a CAM slave line card; instructions for error monitoring the CAM on the slave line card by polling; when a soft-error or datapath link is detected, determining if the number of errors is less than a threshold; when the number of errors is less than a threshold, invoking a CAM slave database refresh process; when the number of errors is greater than a threshold, indicating a hardware fault and halting operation.

### BRIEF DESCRIPTION OF THE DRAWINGS

In order to better understand various embodiments, reference is made to the accompanying drawings, wherein:

FIG. 1 illustrates a network environment;

FIG. 2 illustrates an embodiment of a self-healing CAM datapath;

FIG. 3 illustrates a CAM master error monitoring and response manager method;

FIG. 4 illustrates a CAM slave error monitoring and response manager method; and

FIG. 5 illustrates a datapath link recovery process method.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

There may be multiple ways in which the context information in a CAM datapath lookup device may be corrupted or out-of-sync with the control plane resulting in improper traffic handling for Network Processors (or other devices) doing lookups to the CAM in real-time.

For example, the datapath link communications medium used for Database (DB) updates and lookups, such as a Serializer/Deserializer (SerDes) link, may experience a fault due to soft-error or other transient error or may go down, impacting database operations to the CAM device. Subtle differences in the hardware characteristics between different assemblies may affect the stability of these high speed datapath links. Single-event upsets may happen based on the specifications SerDes links are designed to, for example a bit-error rate (BER) of 10⁻¹² to 10⁻¹⁵. The probability of these errors may increase with the speed of the interface and the number of assemblies which are shipped.

In another example, soft-error(s) may impact stored data in the CAM database array or user data array (normal onboard RAM) which may or may not have ECC protection for correcting single-bit flips. When the CAM device is shared, for example, in a distributed system having multiple linecards, fault recovery may be more complicated.

Accordingly, there is a need for highly-available communications platforms to detect and repair CAM context information being used in a datapath. The CAM device may be shared in a distributed architecture such as a dual-datapath lookup devices, for example, a network processor or application specific integrated circuit (ASIC), or DB management from one or more software applications. In one embodiment, two linecards, each with their own network processor and software application may share a single CAM device. To solve this problem with minimal network downtime and customer impact (IP routing, ACLs etc.), a comprehensive self-healing CAM datapath software solution may include the following capabilities:
Real-time and background monitoring of CAM device including stored data and datapath interface link(s) used to manage and perform lookups to databases and user-data array memory.
A response manager to evaluate error conditions detected and trigger necessary actions.
A retry mechanism for database update failures due to transient error in link from control plane to CAM device.
A software function to recover datapath link(s) to the CAM device which is down.
Software functions to repair databases or user-data array memory contents due to soft-errors such as a single event upset (SEU).
Handling for dual-port applications with CAM master (including control and datapath to device) and CAM slave (has datapath link to the device for managing and doing database lookups).

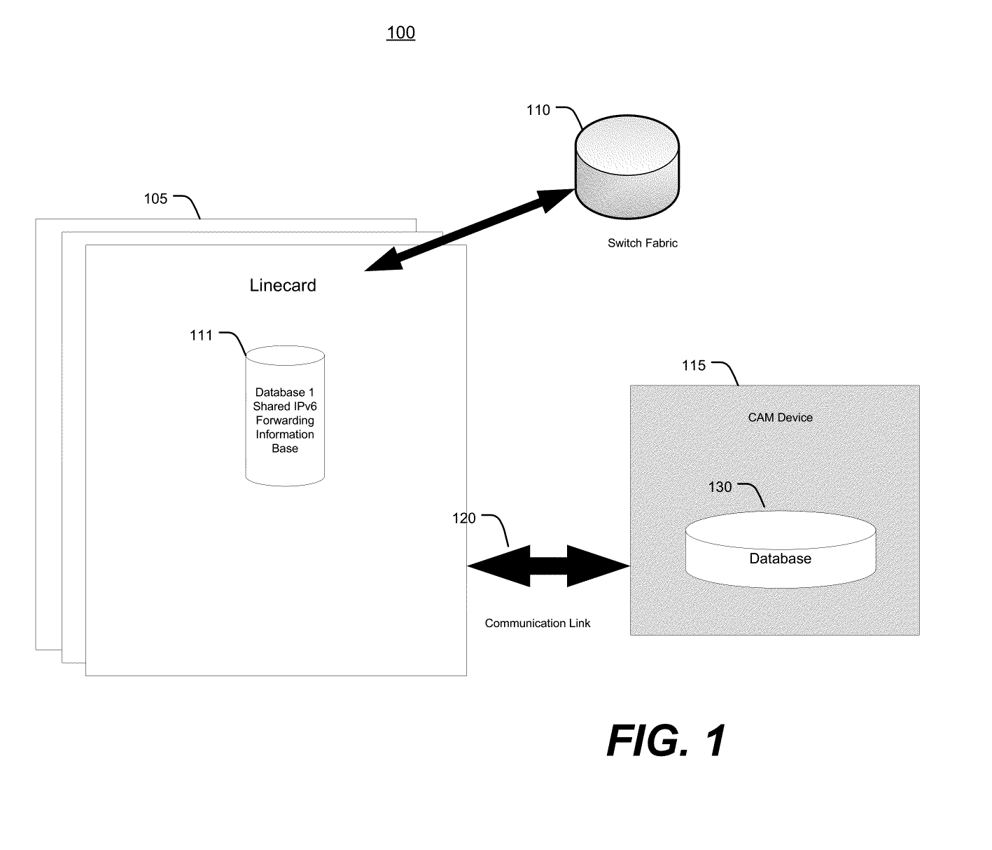

FIG. 1 illustrates a network environment 100. Network environment 100 may include linecard(s) 105, switch fabric 110, CAM device 115, communications link 120, database 130, and database 111. Network environment 100 may be any kind of data or telecommunications network environment such as, for example, a Wide Area Network (WAN), IPv4 or IPv6 network, a Virtual Private Network (VPN), or a Global System for Mobile Communications (GSM) network.

Linecard(s) 105 may be one or more master and/or slave linecard(s) which are connected to CAM device 115. Linecard(s) 105 may for example include interfaces and ports for a data communications network such as Transmission Control Protocol and IP (TCP/IP). Linecard(s) 105 may include database 111 which may include, for example, a shared IPv6 Forwarding Information Base. Database 111 may be stored on any kind of machine readable storage medium. The machine-readable storage medium may include read-only memory (ROM), random-access memory (RAM), magnetic disk storage media, optical storage media, flash-memory devices, and similar storage media.

Linecard(s) 105 may connect to switch fabric 110. Switch fabric 110 may include any type of switching topology including network nodes which are interconnected via switches, or routers for example.

CAM device 115 may compare input data against a table or data structure or data which is stored and return output data which matches that requested. For example, CAM device 115 may also be a ternary CAM or a binary CAM device.

Linecard(s) 105 may be connected or connect through communications link 120 to CAM device 115 in order to access database 130. Database 130 may contain Access Control List(s) or routing tables for example.

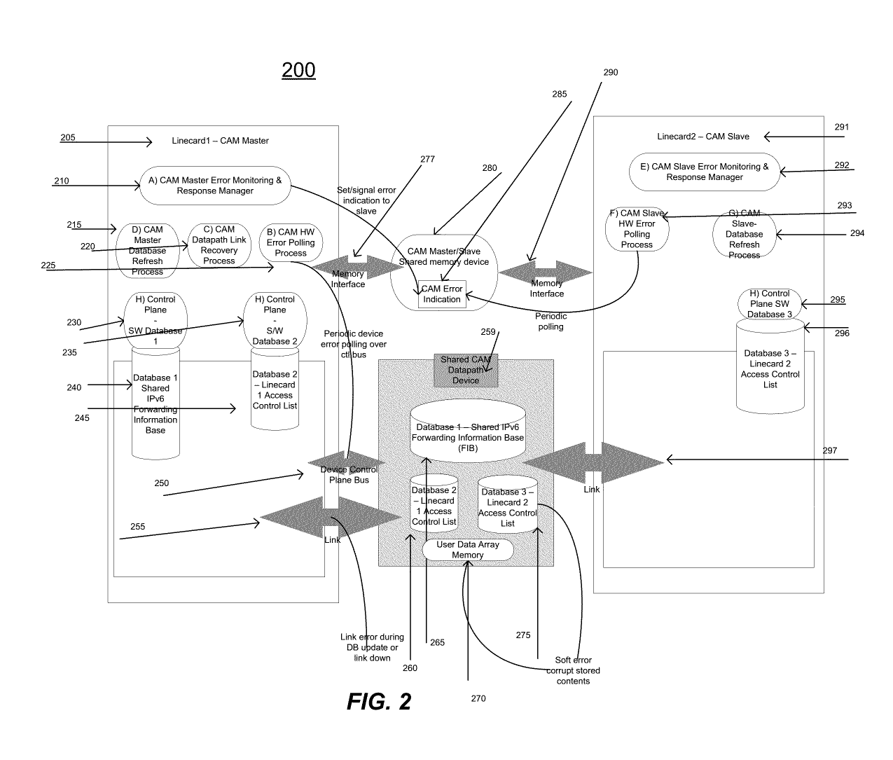

FIG. 2 illustrates an embodiment of a self-healing CAM datapath 200. Embodiment 200 may include, line card 1 205 which may operate as a CAM master, Shared CAM datapath device 259, CAM master/slave shared memory device 280 and line card 2 291 which may operate as a CAM slave.

Line card 1 205 may include, CAM master error monitoring and response manager 210, CAM master database refresh process or module 215, CAM datapath link recovery process module 220, CAM hardware error polling process or module 225, control plane software database 1 230, control plane software database 2 235, database 1 shared IPv6 forwarding information base 240, database 2 line card 1 Access Control List (ACL) 245, device control plane bus 250, and link 255. Link 255 may be connected to a datapath port on linecard 1 205, using a high bandwidth link. Link 255 may be used to perform database lookups and management operations.

CAM master error monitoring and response manager 210 may include a method to ascertain whether a hardware control plane medium failure detected is transient (such as a blip or recoverable) or due to a persistent fault or hardware defect. To accomplish this it may use history and the number of errors detected. Similarly, line card 1 205 may use persistence or reoccurrence of the fault after a recovery/repair process has been invoked.

CAM master error monitoring and response manager 210 may trigger appropriate recovery mechanisms based on faults that are detected. In some embodiments, a method to signal to the CAM slave (if present) to repair a non-locally managed database may be accomplished by writing a CAM error control word to shared memory interface 277 which could be an external RAM, Field Programmable Gate Array (FPGA) block RAM or User-data array memory (onboard SSRAM) in the CAM itself if present.

CAM hardware error polling process or module 225 may include periodic background software checks for hardware error indications. One example of a periodic background software check is detection of hardware error(s) such as alignment, parity, etc. Another example may include detection of Database and/or stored data soft-error(s). Errors may be read from CAM registers or the attached device (Network Processor, ASIC etc. . . . ).

CAM datapath link recovery process or module 220 may include a method to recover the control plane medium such as reconfiguration, realignment or resetting, for master and slave datapath port links to the device.

CAM master database refresh process or module 215 may include a method to repair corrupted information stored in the CAM due to soft-error(s) in a local database or user-data array memory.

CAM control plane database management may occur in control plane software database 1 230, and/or control plane software database 2 235. The control plane database management may include a simple re-try mechanism for database operations (Add/Delete/Move) that may have failed due to transient fault(s) on the master datapath port link.

Shared CAM datapath device 259 may include database 2 line card 1 ACL 260, database 1 shared IPv6 forwarding information base (FIB) 265, user data array memory 270, and database 3 line card 2 ACL 275. Shared CAM datapath device 259 may communicate with linecard 1 205 via link 255 or device control plane bus 250.

CAM master/slave shared memory device 280 may include shared memory interface 277, CAM error indication or module 285, and memory interface 290. Memory interface 277 may be used to communicate with linecard 1 205 in order to set and/or signal CAM error indications in master/slave shared memory device 280. Similarly, linecard 2 291 may be communicated with via memory interface 290. Linecard 2 291 may perform periodic polling of the CAM error indication or module 285 and local datapath link to CAM 297.

In some embodiments which include two line cards, including a line card that acts as a CAM slave the processes and components of line card 2 291 may be included. Line card 2 291 may include CAM slave error monitoring and response manager 292, CAM slave hardware error polling process 293, CAM slave database refresh process or module 294, control plane software database 3 295, database 3 linecard 2 ACL 296, and link 297. Link 297 may be attached to a datapath port of linecard 2 291 via a high bandwidth link. Link 297 may be used for database lookups and management operations.

In linecard 2 291, CAM slave error monitoring and response manager 292 may trigger a Slave Database recovery/refresh process based on a signal from the master or detection of a local datapath link error. The CAM slave error monitoring and response manager 292 may function similarly to CAM master error monitoring and response manager 210, but as a slave under control of the master.

CAM slave HW error polling process 293 may include periodic background software checks for hardware error indications. It may communicate with linecard 1 205 via the shared memory interface 290 for error indications from the CAM master and read registers to detect local datapath link 297 errors. CAM slave HW error polling process 293 may check for error indications in CAM master/slave shared memory device 280 as set by master and link errors detected locally on receiver side of link 297. The slave may not be able to perform the datapath link down recovery like the master, with full control plane to CAM device

CAM slave database refresh process or module 294 may include a method to repair corrupted information stored in the CAM due to soft-error(s) for a local slave managed database similar to CAM master database refresh process or module 215.

CAM control plane database management may include control plane software database 3 295 which includes a retry mechanism for database operations such as add, delete, or move, that may have failed due to a transient fault on the slave datapath port link similar to link 255.

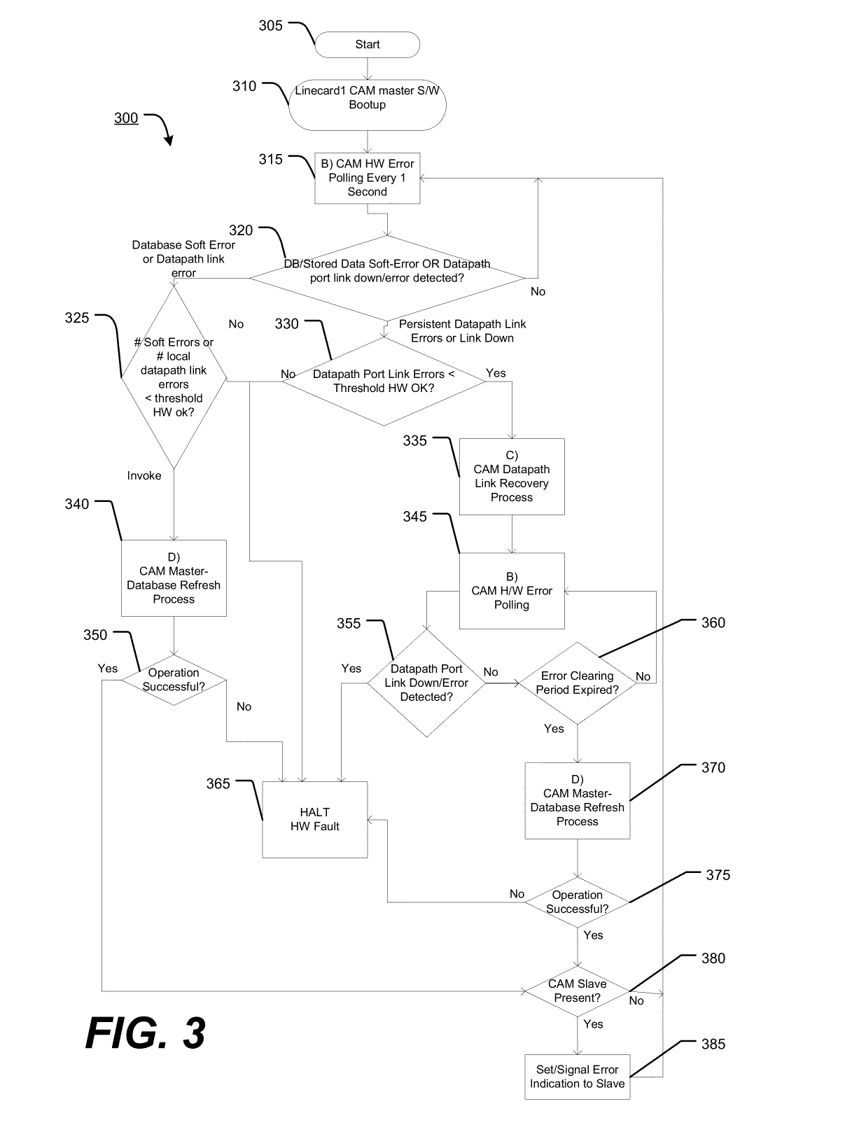

FIG. 3 illustrates a CAM master error monitoring and response manager method 300. In method 300, linecard 1 205 may begin in step 305 and proceed to step 310 where it may perform a software bootup procedure.

Linecard 1 205 may proceed to step 315 where it may begin hardware error polling. Hardware error polling may occur on any interval such as 0.5, 1 or 2 seconds.

Linecard 1 205 may proceed to step 320 where it may determine whether a database or stored data has a soft error, or that a datapath port link is down or has an error detected. When no database or stored data is detected to have a soft error and no datapath port link is down or has an error detected, then linecard 1 205 may proceed to step 315 where it may continue hardware error polling.

Linecard 1 205 may proceed to step 330 when a persistent datapath link error or link down has been detected. In step 330, linecard 1 205 may determine if the number of datapath port link errors are greater than a threshold. When the number of datapath port link errors are greater than the threshold then linecard 1 205 may proceed to step 365 where it may halt operation and indicate that a fault is present. When the number of errors are less than the threshold, then linecard 1 205 may proceed to step 335 where it may begin a CAM datapath link recovery process.

Once linecard 1 205 has executed the datapath link recovery process to completion, it may proceed to step 345 where it begins hardware error polling to ascertain whether the recovery operation was successful.

Linecard 1 205 may proceed to step 355 after hardware error polling has begun in step 345. In step 355, linecard 1 205 may determine persistence of the datapath port link down or errors detected. When persistent errors or link down are detected, linecard 1 205 may proceed to step 365 where it may halt operation and indicate that a fault exists. When the datapath port is up and no errors are detected, linecard 1 205 may proceed to step 360 where it may determine if the error clearing period has expired. This increases certainty that recovery was successful due to a transient fault.

Linecard 1 205 may proceed to step 345 when it has determined that the error clearing period has not expired. Linecard 1 205 may proceed to step 370 when it has determined that the error clearing period has expired. In step 370, linecard 1 205 may begin the CAM master database refresh process.

Linecard 1 205 may proceed to step 375 once the CAM master database refresh process has completed where it may decide whether the operation was successful as determined by database refresh operations that complete without newly detected errors. When linecard 1 205 determines that the operation was not successful it may proceed to step 365 where it may halt operation and indicate that there was a hardware fault. When linecard 1 205 determines that operation was successful, it may proceed to step 380 where it may determine whether a CAM slave linecard is present using the same CAM.

Linecard 1 205 may proceed to step 385 when it determines that a slave is present. Linecard 1 205 may proceed to step 315 when it determines that a slave is not present.

In step 385, linecard 1 205 may set or signal to an error indication to a slave linecard. Once signaling is complete, linecard 1 205 may proceed to step 315 where it may begin hardware error polling again.

After determining that a database soft error or datapath link error has occurred in step 320, linecard 1 205 may proceed to step 325 where it may determine if the number of errors is greater than or less than a threshold. When the number of errors is greater than the threshold, then linecard 1 205 may determine that there is a hardware fault and halt operation in step 365. When the number of errors is less than the threshold, then linecard 1 205 may determine that the hardware is OK and proceed to step 340.

In step 340, linecard 1 205 may invoke a CAM master database refresh process.

Linecard 1 205 may proceed to step 350 where it may determine if the CAM master database refresh process was successful as determined by database refresh operations that complete without newly detected errors. When linecard 1 205 determines that the database refresh process was not successful, it may proceed to step 365 where it may halt and indicate that there is a hardware fault. When linecard 1 205 determines that the database refresh process is successful, it may proceed to step 380 where it may determine if there is a CAM slave present on the system.

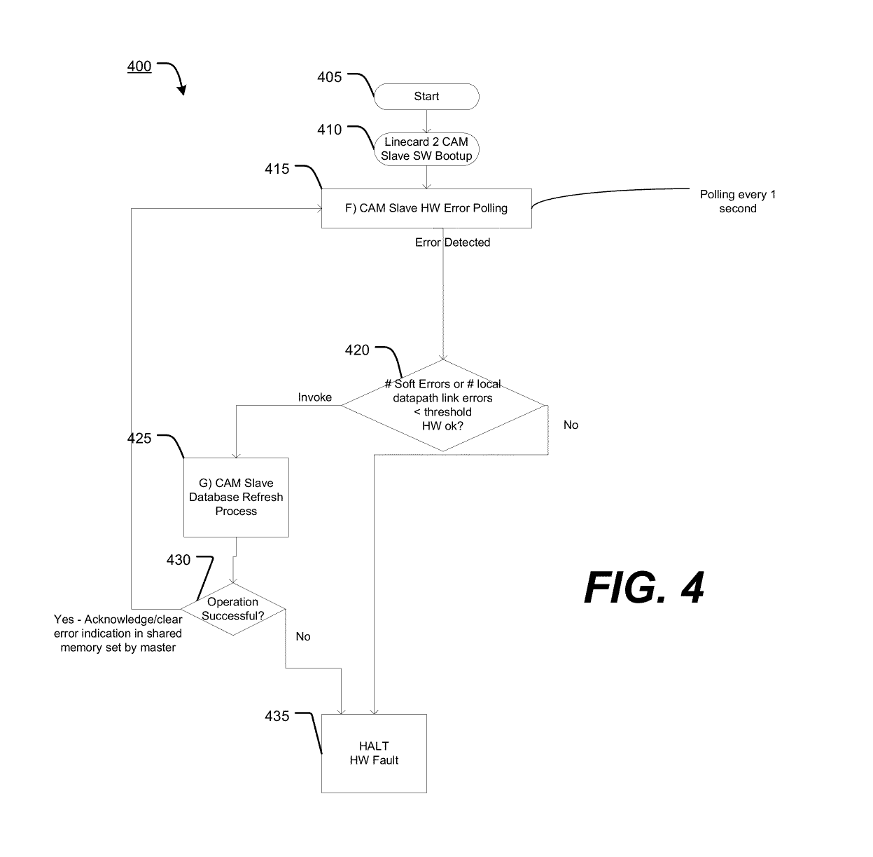

FIG. 4 illustrates a CAM slave error monitoring and response manager method 400. In method 400, linecard 2 291 may begin in step 405 and proceed to step 410 where linecard 2 291 may bootup its software.

Linecard 2 291 may proceed to step 415 where it may poll for CAM slave HW errors as indicated by master or detected locally on datapath port link to CAM. Monitoring the CAM errors of the slave linecard may include polling at an interval of time such as 0.5, 1 or 2 seconds.

When linecard 2 291 detects an error, it may proceed to step 420. In step 420, linecard 2 291 may determine if the number of soft errors or local datapath link errors are greater than or less than a threshold. When the number of errors are greater than the threshold linecard 2 291 may proceed to step 435 where it may decide to halt because of a hardware fault is detected. When the number of errors are less than the threshold then linecard 2 291 may proceed to step 425 where it may invoke the CAM slave database refresh process.

After linecard 2 291 has invoked CAM slave database refresh process in step 425, it may proceed to step 430 where it may decide if the operation is successful. When the operation is successful, the slave may acknowledge/clear the error indication in the shared memory which was set by master. When the operation is determined to be successful, linecard 2 291 may proceed to step 415 where it continues error monitoring. When the operation is determined not to be successful, linecard 2 291 may proceed to step 435 where it may indicate a hardware fault.

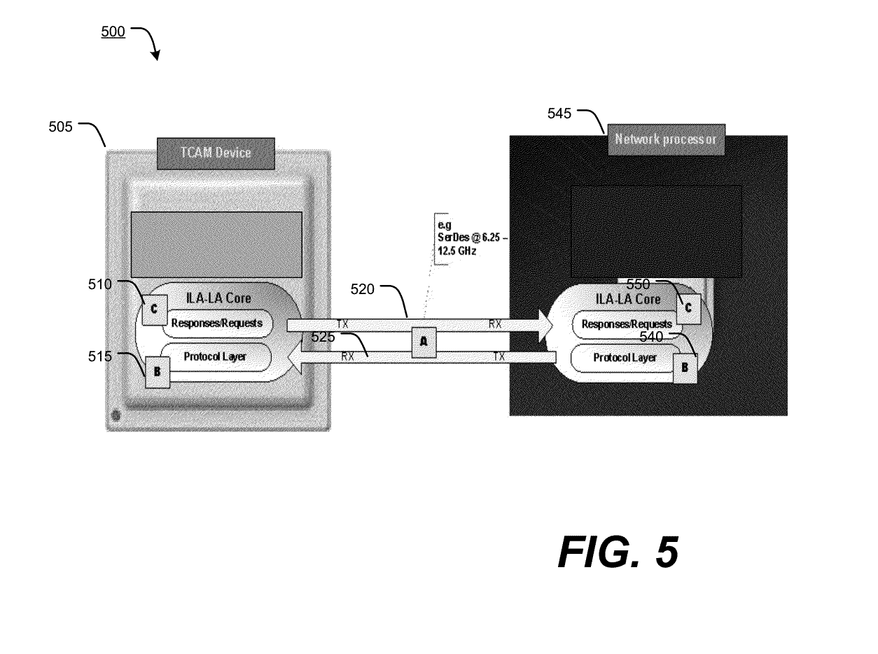

FIG. 5 illustrates a method of a datapath link recovery process 500. Method 500 may include TCAM device 505, and network processor 545. In one embodiment, the datapath links to the TCAM device are general interlaken look-aside (ILA-LA) serial interfaces.

ILA-LA is a standardized protocol to facilitate interoperability between a datapath device such as a TCAM and a lookup co-processor such as a NP or ASIC. ILA-LA is a protocol that is suitable for short, transaction related transfers which may be described in three layers including:

A) Physical layer 520 where circuits and components are used to transmit/receive data through a physical medium.

B) Protocol layer 515 which may include logic implementation for the ILA-LA.

C) Application layer 510 where ILA-LA packets may be sent and/or acknowledged, for example in transactions, over the interface for both database updates and for lookups.

To recover an active ILA-LA datapath link (down or with errors detected in physical layer 520 or protocol layer 515) to the TCAM device, software may perform the following steps:

1) Flush any ILA-LA transactions, such as datapath lookups or updates, in progress and suspend further transactions from application layer 510 until link recovery is complete. This may result in temporary traffic outage until step 7) is reached.

2) Disable ILA-LA core transmit and receive (TX, RX) on the Network Processor side, then re-enable only the TX. The ILA-LA Core may start transmitting a training sequence consisting of idle control words for the ILA-LA RX on the TCAM to use for hardware alignment.

3) Immediately reset both the ILA-LA TX/RX on the TCAM side to re-start the alignment process on its own ILA-LA RX. The TCAM ILA-LA TX also starts transmitting a training sequence as in 2) for the Network Processor.

4) Enable ILA-LA RX on the Network Processor to allow alignment with the TCAM ILA-LA TX transmitter.

5) At this stage the ILA-LA interface link should be back up. Clear/reset all hardware error indications in the device following the reinitialization.

6) Look for any subsequent (persistent) errors being reported to ascertain whether link recovery was successful or not. This may be accomplished via the TCAM hardware error monitoring process.

7) Resume ILA-LA transactions in Application layer 510.

It should be apparent from the foregoing description that various embodiments of the invention may be implemented in hardware and/or firmware. Furthermore, various embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor may be explicitly shown.

Although the various embodiments have been described in detail with particular reference to certain aspects thereof, it should be understood that the invention may be capable of other embodiments and its details are capable of modifications in various obvious respects. As may be readily apparent to those skilled in the art, variations and modifications may be affected while remaining within the spirit and scope of the invention. Accordingly, the foregoing disclosure, description, and figures are for illustrative purposes only and do not in any way limit the invention, which may be defined only by the claims.

What is claimed is:

1. A method for monitoring a Content Addressable Memory (CAM) comprising:
performing CAM hardware error polling;
determining that a stored data soft error or datapath link error is present;
comparing the number of errors to a threshold;
when the number of errors is less than the threshold, invoking a master line-card stored data refresh process;
determining a datapath port link error's detection; and
when the datapath port link is down or persistent errors are present, invoking a datapath port link recovery process including hardware error polling to ascertain whether recovery operation was successful.

2. The method of claim 1 wherein:
when the number of stored data soft errors or datapath link errors is larger than the threshold, indicating a hardware fault and halting operation.

3. The method of claim 1 wherein:
when the master stored data refresh process is not successful as determined by newly encountered errors in the refresh process, indicating a hardware fault and halting operation.

4. The method of claim 1 further comprising:
determining if a datapath port link is down or persistent errors are detected; and
when a datapath port link is down of has persistent errors detected, indicating a hardware fault and halting operation.

5. The method of claim 1 wherein when datapath port link errors are no longer detected following a recovery operation, determining if an error clearing period has expired.

6. The method of claim 5 wherein,
when the error clearing period has expired, performing a CAM master database refresh process and deciding if the CAM master database refresh process was successful, determined by database refresh operations that completed without newly detected errors.

7. The method of claim 1 wherein the CAM is a ternary CAM connected to a linecard.

8. The method of claim 1 further comprising:
booting up a CAM slave line card;
error monitoring the CAM on the slave line card by polling;
when an error is detected, determining if the number of soft errors or local datapath link errors is less than a threshold;
when the number of errors is less than a threshold, invoking a CAM slave database refresh process;
when the number of errors is greater than a threshold, indicating a hardware fault and halting operation.

9. A device used for monitoring a Content Addressable Memory (CAM), the device including:
a memory; and
a processor configured to:
perform CAM hardware error polling;
determine that a stored data soft error or datapath link error is present;
compare the number of stored data soft errors or datapath link errors to a threshold;
when the number of stored data soft errors or datapath link errors is less than the threshold, invoking a master stored data refresh process;
determine a datapath port link error's detection; and
when a datapath port link is down or persistent errors are present, invoke a datapath port link recovery process including hardware error polling to ascertain whether recovery operation was successful.

10. The device of claim 9 wherein when the number of stored data soft errors or datapath link errors is larger than the threshold, the processor is further configured to indicate a hardware fault and halt operation.

11. The device of claim 9 wherein the processor is further configured to:
boot up a CAM slave line card;
error monitor the CAM on the slave line card by polling;
when a database soft-error or datapath link error is detected, determine if the number of errors is less than a threshold;
when the number of errors is greater than a threshold, invoke a CAM slave database refresh process;
when the number of errors is greater than a threshold, indicate a hardware fault and halting operation.

12. A tangible and non-transitory machine-readable storage medium encoded with instructions thereon for executing a method for monitoring a Content Addressable Memory (CAM), wherein said tangible and non-transitory machine-readable storage medium comprises:
instructions for performing CAM hardware error polling;
instructions for determining that a stored data soft error or datapath link error is present;
instructions for comparing the number of stored data soft errors or datapath link errors to a threshold;
when the number of stored data soft errors or datapath link errors is less than the threshold, invoking a master line-card stored data refresh process;
instructions for determining a datapath port link error's detection; and
when a datapath port link is down or persistent errors are present, invoking a datapath port link recovery process including hardware error polling to ascertain whether recovery operation was successful.

13. The tangible and non-transitory machine-readable storage medium of claim 12 wherein:
when the number of stored data soft errors or datapath link errors is larger than the threshold, indicating a hardware fault and halting operation.

14. The tangible and non-transitory machine-readable storage medium of claim 12 wherein:
when the master stored data refresh process is not successful, indicating a hardware fault and halting operation.

15. The tangible and non-transitory machine-readable storage medium of claim 12 further comprising:
instructions for determining if a datapath port link is down or persistent errors are detected; and
when a datapath port link is down or persistent errors are detected, indicating a hardware fault and halting operation.

16. The tangible and non-transitory machine-readable storage medium of claim 12 wherein when a datapath port link error is not detected, determining if a error clearing period has expired.

17. The tangible and non-transitory machine-readable storage medium of claim 16 wherein,
when the error clearing period has expired, performing a CAM master database refresh process and determining if the CAM master database refresh process was successful.

18. The tangible and non-transitory machine-readable storage medium of claim 12 wherein the CAM is a ternary CAM connected to a linecard.

19. The tangible and non-transitory machine-readable storage medium of claim 12 further comprising:
instructions for booting up a CAM slave line card;
instructions for error monitoring the CAM on the slave line card by polling;
when a database soft-error or datapath link error is detected, determining if the number of errors is less than a threshold;
when the number of errors is less than a threshold, invoking a CAM slave database refresh process;
when the number of errors is greater than a threshold, indicating a hardware fault and halting operation.
